(19) United States
(12) Patent Application Publication
(10) Pub. No.: US 2018/0112600 A1
(43) Pub. Date: Apr. 26, 2018

(54) STARTER AIR VALVE SYSTEM WITH REGULATING BLEED

(71) Applicant: HAMILTON SUNDSTRAND CORPORATION, Charlotte, NC (US)

(72) Inventors: Myles R. Kelly, Willimantic, CT (US); James S. Elder, South Windsor, CT (US)

(21) Appl. No.: 15/299,649

(22) Filed: Oct. 21, 2016

(51) Int. Cl. F02C 7/277; F02C 9/18

(52) U.S. Cl. CPC F02C 7/277; F05D 2260/85; F02C 9/18

(57) ABSTRACT

A system includes a starter air valve with a manual override and a pressure regulating bleed valve in fluid communication with the starter air valve. The starter air valve is in fluid communication with an air turbine starter to drive motoring of a gas turbine engine responsive to a compressed air flow from a compressed air source. The pressure regulating bleed valve is operable to bleed a portion of the compressed air flow to produce a bleed controlled starter air flow to limit a motoring speed of the gas turbine engine below a resonance speed of the gas turbine engine responsive to detection of the manual override in an open position.

### BACKGROUND

This disclosure relates to gas turbine engines, and more particularly to a starter air valve system with a pressure regulating bleed valve for gas turbine engine motoring.

Gas turbine engines are used in numerous applications, one of which is for providing thrust to an airplane. When the gas turbine engine of an airplane has been shut off for example, after the airplane has landed at an airport, the engine is hot and due to heat rise, the upper portions of the engine will be hotter than lower portions of the engine. When this occurs thermal expansion may cause deflection of components of the engine which can result in a “bowed rotor” condition. If a gas turbine engine is in such a bowed rotor condition, it is undesirable to restart or start the engine.

One approach to mitigating a bowed rotor condition is to use a starter system to drive rotation (i.e., cool-down motoring) of a spool within the engine for an extended period of time at a speed below which a resonance occurs (i.e., a critical speed or frequency) that may lead to damage when a sufficiently large bowed rotor condition is present. If a starter air valve of the starter system fails closed, the starter system may be incapable of performing cool-down motoring. Manual operation of the valve may be incapable of accurate control of the cool-down motoring speed, potentially reaching the resonance speed.

### BRIEF DESCRIPTION

In an embodiment, a system includes a starter air valve with a manual override and a pressure regulating bleed valve in fluid communication with the starter air valve. The starter air valve is in fluid communication with an air turbine starter to drive motoring of a gas turbine engine responsive to a compressed air flow from a compressed air source. The pressure regulating bleed valve is operable to bleed a portion of the compressed air flow to produce a bleed controlled starter air flow to limit a motoring speed of the gas turbine engine below a resonance speed of the gas turbine engine responsive to detection of the manual override in an open position.

In addition to one or more of the features described above, or as an alternative to any of the foregoing embodiments, further embodiments may include where the compressed air source is an auxiliary power unit, a ground cart, or a cross-engine bleed.

In addition to one or more of the features described above, or as an alternative to any of the foregoing embodiments, further embodiments may include a torque motor operable to open the pressure regulating bleed valve.

In addition to one or more of the features described above, or as an alternative to any of the foregoing embodiments, further embodiments may include a solenoid operable to open the pressure regulating bleed valve.

In addition to one or more of the features described above, or as an alternative to any of the foregoing embodiments, further embodiments may include a switch operable to detect the manual override in the open position.

In addition to one or more of the features described above, or as an alternative to any of the foregoing embodiments, further embodiments may include a sensor operable to detect the manual override in the open position.

In addition to one or more of the features described above, or as an alternative to any of the foregoing embodiments, further embodiments may include where the starter air valve and the pressure regulating bleed valve are integrally formed as a single line replaceable unit.

In an embodiment, a system of an aircraft includes an air turbine starter coupled to a gearbox, a starter air valve with a manual override, a pressure regulating bleed valve in fluid communication with the starter air valve, and a controller. The starter air valve is in fluid communication with the air turbine starter to drive motoring of a gas turbine engine responsive to a compressed air flow from a compressed air source. The controller is operable to actuate the pressure regulating bleed valve to bleed a portion of the compressed air flow to produce a bleed controlled starter air flow to limit a motoring speed of the gas turbine engine below a resonance speed of the gas turbine engine responsive to detection of the manual override in an open position.

In addition to one or more of the features described above, or as an alternative to any of the foregoing embodiments, further embodiments may include where the controller is operable to drive a torque motor to adjust the pressure regulating bleed valve.

In addition to one or more of the features described above, or as an alternative to any of the foregoing embodiments, further embodiments may include where the controller is operable to drive a solenoid to open the pressure regulating bleed valve.

In addition to one or more of the features described above, or as an alternative to any of the foregoing embodiments, further embodiments may include where the controller is coupled to a switch operable to detect the manual override in the open position.

In addition to one or more of the features described above, or as an alternative to any of the foregoing embodiments, further embodiments may include where the controller is coupled to a sensor operable to detect the manual override in the open position.

In an embodiment, a method includes detecting a manual override of a starter air valve in an open position, where the starter air valve is in fluid communication with an air turbine starter to drive motoring of a gas turbine engine responsive to a compressed air flow from a compressed air source. The method also includes controlling a pressure regulating bleed valve in fluid communication with the starter air valve to bleed a portion of the compressed air flow to produce a bleed controlled starter air flow to limit a motoring speed of the gas turbine engine below a resonance speed of the gas turbine engine responsive to detection of the manual override in the open position.

In addition to one or more of the features described above, or as an alternative to any of the foregoing embodiments, further embodiments may include controlling a torque motor to open the pressure regulating bleed valve.

In addition to one or more of the features described above, or as an alternative to any of the foregoing embodiments, further embodiments may include controlling a solenoid to open the pressure regulating bleed valve.

In addition to one or more of the features described above, or as an alternative to any of the foregoing embodiments, further embodiments may include where the open position of the manual override is detected based on a switch.

In addition to one or more of the features described above, or as an alternative to any of the foregoing embodiments, further embodiments may include where the open position of the manual override is detected based on a sensor.

A technical effect of the systems and methods is achieved by using a starter air valve with a pressure regulating bleed valve for gas turbine engine motoring as described herein.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a schematic illustration of an aircraft engine starting system in accordance with an embodiment of the disclosure;

FIG. 2 is another schematic illustration of an aircraft engine starting system in accordance with an embodiment of the disclosure; and

FIG. 3 is a flow chart illustrating a method in accordance with an embodiment of the disclosure.

### DETAILED DESCRIPTION

Various embodiments of the present disclosure are related to a bowed rotor start mitigation system in a gas turbine engine. Embodiments can include using a starter air valve to control a rotor speed of a starting spool of a gas turbine engine to mitigate a bowed rotor condition using a cool-down motoring process. Under normal operation during cool-down motoring, the starter air valve can be actively adjusted to deliver air pressure (i.e., compressed air) from an air supply to an air turbine starter of an engine starting system that controls starting spool rotor speed. Cool-down motoring may be performed by running an engine starting system at a lower speed with a longer duration than typically used for engine starting while dynamically adjusting the starter air valve to maintain a rotor speed and/or profile. A critical rotor speed refers to a major resonance speed where, if the temperatures are unhomogenized, the combination of a bowed rotor and similarly bowed casing and the resonance would lead to high amplitude oscillation in the rotor and high rubbing of blade tips on one side of the rotor, especially in a high pressure compressor, for example.

In embodiments, when a starter air valve fails shut, a manual override can be adjusted to open the starter air valve, and a pressure regulating bleed valve can be used to establish a regulated pressure to limit a motoring speed of the gas turbine engine below a resonance speed of a starting spool of the gas turbine engine.

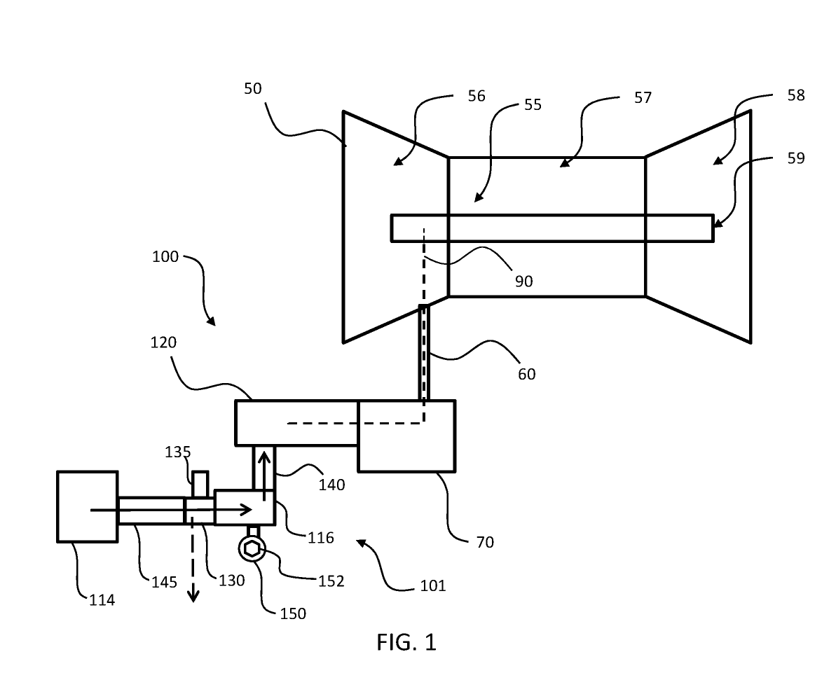

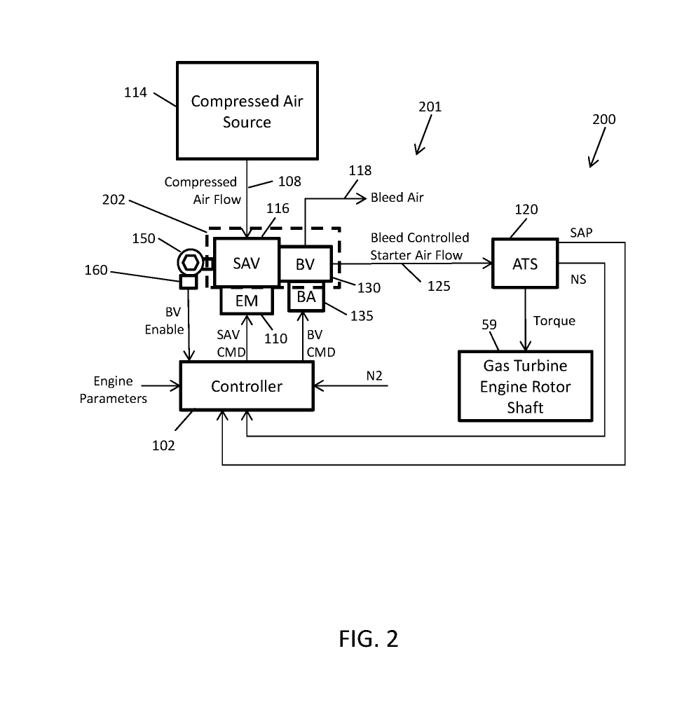

Referring now to the figures, FIG. 1 shows a block diagram of a gas turbine engine 50 and an associated engine starting system 100 with a valve system 101 according to an embodiment of the present disclosure. The valve system 101 includes a starter air valve 116 and a pressure regulating bleed valve 130 operably connected in fluid communication with an air turbine starter 120 of the engine starting system 100 through at least one duct 140. The valve system 101 is operable to receive a compressed air flow from a compressed air source 114 through one or more ducts 145. The compressed air source 114 can be an auxiliary power unit, a ground cart, or a cross-engine bleed. The pressure regulating bleed valve 130 can be driven (e.g., bleed opened/closed) by a bleed actuator 135, such as a torque motor or solenoid, which can be locally or remotely positioned with respect to the pressure regulating bleed valve 130. Although the pressure regulating bleed valve 130 is depicted upstream from the starter air valve 116 with respect to the compressed air source 114, in other embodiments, the pressure regulating bleed valve 130 is position between the starter air valve 116 and the air turbine starter 120 (FIG. 2). Furthermore, the starter air valve 116 and the pressure regulating bleed valve 130 can be integrated into a single line replaceable unit.

The air turbine starter 120 of the engine starting system 100 is operably connected to the gas turbine engine 50 through an accessory gearbox 70 and drive shaft 60 (e.g., a tower shaft), as shown in FIG. 1. As depicted in the example of FIG. 1, the air turbine starter 120 is connected to the gas turbine engine 50 by a drive line 90, which runs from an output of the air turbine starter 120 to the accessory gearbox 70 through the drive shaft 60 to a rotor shaft 59 of the gas turbine engine 50. Operable connections can include gear mesh connections that in some instances can be selectively engaged or disengaged, for instance, through one or more clutches. The air turbine starter 120 is configured to initiate a startup process of the gas turbine engine 50 driving rotation of the rotor shaft 59 of a starting spool 55 of the gas turbine engine 50. The rotor shaft 59 operably connects an engine compressor 56 to an engine turbine 58. Thus, once the engine compressor 56 starts spinning, air is pulled into combustion chamber 57 and mixes with fuel for combustion. Once the air and fuel mixture combusts in the combustion chamber 57, a resulting compressed gas flow drives rotation of the engine turbine 58, which rotates the engine turbine 58 and subsequently the engine compressor 56. Once the startup process has been completed, the air turbine starter 120 can be disengaged from the gas turbine engine 50 to prevent over-speed conditions when the gas turbine engine 50 operates at its normal higher speeds. Although only a single instance of an engine compressor-turbine pair of starting spool 55 is depicted in the example of FIG. 1, it will be understood that embodiments can include any number of spools, such as high/mid/low pressure engine compressor-turbine pairs within the gas turbine engine 50.

The air turbine starter 120 is further operable to drive rotation of the rotor shaft 59 at a lower speed for a longer duration than typically used for engine starting in a motoring mode of operation (also referred to as cool-down motoring) to prevent/reduce a bowed rotor condition. If a bowed rotor condition has developed, for instance, due to a hot engine shutdown and without taking further immediate action, cool-down motoring may be performed by the air turbine starter 120 to reduce a bowed rotor condition by driving rotation of the rotor shaft 59.

A controller, such as full authority digital engine control (FADEC) 102 (FIG. 2), typically controls valve operation, for instance, modulation of the starter air valve 116 to control a motoring speed of the gas turbine engine 50 during cool-down motoring. If the starter air valve 116 fails shut, a corresponding manual override 150 can be used to manually open the starter air valve 116. The manual override 150 can include a tool interface 152 to enable a ground crew to open the starter air valve 116. When starter air valve 116 fails shut and manual override 150 can be used to open the starter air valve 116. The pressure regulating bleed valve 130 can be controlled to provide a regulated pressure to drive rotation of the air turbine starter 120 for cool-down motoring of the gas turbine engine 50. For example, the bleed actuator 135 can selectively open the pressure regulating bleed valve 130 to limit a motoring speed of the gas turbine engine 50 below a resonance speed of the starting spool 55 of the gas turbine engine 50 responsive to a compressed air flow from the compressed air source 114. Control of the pressure regulating bleed valve 130 can be enabled responsive to a manual override state detector 160 (FIG. 2), which may be a switch or sensor that indicates whether the manual override 150 is in an open position.

Turning now to FIG. 2, another embodiment of an engine starting system 200 of an aircraft is depicted. Similar to FIG. 1, the engine starting system 200 includes a valve system 201 in fluid communication with the air turbine starter 120 to drive motoring of the rotor shaft 59 of the gas turbine engine 50 of FIG. 1 responsive to a compressed air flow 108 from the compressed air source 114. In the example of FIG. 2, the valve system 201 includes the bleed valve 130 positioned between the starter air valve 116 and the air turbine starter 120. The valve system 201 may include a common housing 202 shared by the bleed valve 130 and the starter air valve 116 such that the valve system 201 is a single line replaceable unit.

A controller 102, such as a FADEC, can control operation of the gas turbine engine 50 of FIG. 1 and the valve system 201. In an embodiment, the controller 102 can include memory to store instructions that are executed by one or more processors on one or more channels. The executable instructions may be stored or organized in any manner and at any level of abstraction, such as in connection with a controlling and/or monitoring operation of the gas turbine engine 50 of FIG. 1. The one or more processors can be any type of central processing unit (CPU), including a general purpose processor, a digital signal processor (DSP), a microcontroller, an application specific integrated circuit (ASIC), a field programmable gate array (FPGA), or the like. Also, in embodiments, the memory may include random access memory (RAM), read only memory (ROM), or other electronic, optical, magnetic, or any other computer readable medium onto which is stored data and control algorithms in a non-transitory form.

The controller 102 can be configured with control laws to maintain a motoring speed below a threshold level (i.e., the resonance speed) for the gas turbine engine 50 of FIG. 1 while performing cool-down motoring based on compressed air source 114. In embodiments, the controller 102 can observe various engine parameters and starting system parameters to actively control cool-down motoring and prevent fault conditions from damaging the gas turbine engine 50. For example, controller 102 can observe engine speed (N2) of gas turbine engine 50 and may receive starter system parameters such as starter speed (NS) and/or starter air pressure (SAP).

Under normal operating conditions, one or more channels of the controller 102 can alternate on and off commands to an electromechanical device 110 coupled to the starter air valve 116 to achieve a partially open position of the starter air valve 116 to control a flow of compressed air from compressed air source 114 as a starter air flow to air turbine starter 120 during cool-down motoring. The air turbine starter 120 outputs torque to drive rotation of gas turbine engine shaft 59 of the starting spool 55 of the gas turbine engine 50 of FIG. 1. The controller 102 can monitor engine speed (N2), starter speed (NS), starter air pressure (SAP), and/or other engine parameters to determine an engine operating state and control the starter air valve 116. Thus, the controller 102 can establish a control loop with respect to a motoring speed (N2 and/or NS) and/or starter air pressure (SAP) to adjust positioning of the starter air valve 116.

In some embodiments, the starter air valve 116 is a discrete valve designed as an on/off valve that is typically commanded to either fully opened or fully closed. However, there is a time lag to achieve the fully open position and the fully closed position. By selectively alternating an on-command time with an off-command time through the electromechanical device 110, intermediate positioning states (i.e., partially opened/closed) can be achieved. The controller 102 can modulate the on and off commands (e.g., as a duty cycle using pulse width modulation) to the electromechanical device 110 to further open the starter air valve 116 and increase a rotational speed of the gas turbine engine shaft 59. Pneumatic lines or mechanical linkage (not depicted) can be used to drive the starter air valve 116 between the open position and the closed position. The electromechanical device 110 can be a solenoid that positions the starter air valve 116 based on intermittently supplied electric power as commanded by the controller 102. In an alternate embodiment, the electromechanical device 110 is an electric valve controlling muscle air to adjust the position of the starter air valve 116 as commanded by the controller 102.

In an alternate embodiment, rather than using the electromechanical device 110 to achieve a partially open position of the starter air valve 116, the starter air valve 116 can be a variable position valve that is dynamically adjustable to selected valve angles by the controller 102. When implemented as variable position valves, the starter air valve 116 can be continuous/infinitely adjustable and hold a commanded valve angle, which may be expressed in terms of a percentage open/closed and/or an angular value (e.g., degrees or radians). Performance parameters of the starter air valve 116 can be selected to meet dynamic response requirements. In some embodiments, the controller 102 can monitor a valve angle of the starter air valve 116 when valve angle feedback is available. The controller 102 can establish an outer control loop with respect to motoring speed and an inner control loop with respect to the valve angle of the starter air valve 116.

The controller 102 can track events that impact available compressed air for cool-down motoring at the engine starting system 200. For example, when starter air valve 116 is opened as a result of manual override 150, the controller 102 may command the pressure regulating bleed valve 130 open to regulate a compressed air flow 108 from the compressed air source 114 and adjust a bleed controlled starter air flow 125 by bleeding a portion of the compressed air flow 108 as bleed air 118 to limit the motoring speed of the starting gas turbine engine 50 below a resonance speed of the starting spool 55 of the gas turbine engine 50 responsive to detection of the manual override 150 in an open position. The manual override state detector 160 can be monitored by the controller 102 to detect of the manual override 150 in an open position as a bleed valve enable signal that initiates the release of bleed air 118 from the pressure regulating bleed valve 130 by driving the bleed actuator 135 fully open.

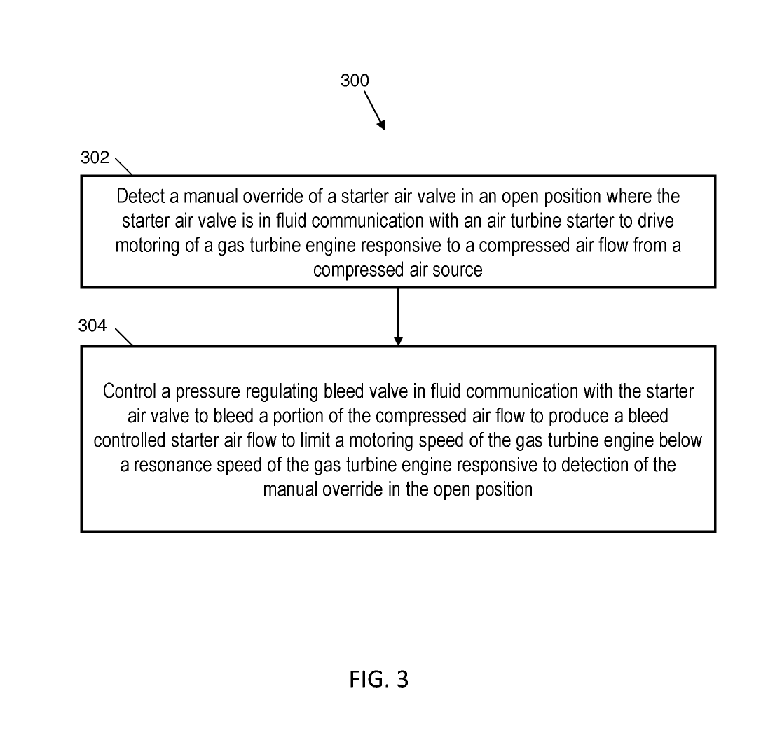

FIG. 3 is a flow chart illustrating a method 300 for gas turbine engine motoring in accordance with an embodiment. The method 300 of FIG. 3 is described in reference to FIGS. 1-2 and may be performed with an alternate order and include additional steps. Before initiating bowed rotor start mitigation, a bowed rotor determination step can be performed to estimate a need for bowed rotor start mitigation. Examples include the use of models and/or stored/observed engine/aircraft state data of the gas turbine engine 50. A non-responsive starter air valve 116 can be fully opened using the manual override 150, and the process 300 can be performed.

At block 302, a manual override 150 of a starter air valve 116 is detected in an open position based on the manual override state detector 160. The starter air valve 116 is in fluid communication with air turbine starter 120 to drive motoring of the gas turbine engine 50 responsive to a compressed air flow 108 from a compressed air source 114. The compressed air source 114 can be an auxiliary power unit, a ground cart, or a cross-engine bleed from another engine (not depicted).

At block 304, a pressure regulating bleed valve 130 in fluid communication with the starter air valve 116 is commanded fully open to bleed a portion of the compressed air flow 108 to produce a bleed controlled starter air flow 125 to limit a motoring speed of the gas turbine engine 50 below a resonance speed of the gas turbine engine 50 responsive to detection of the manual override 150 in the open position. A torque motor or solenoid of the bleed actuator 135 can be controlled to fully open the pressure regulating bleed valve 130. The open position of the manual override 150 can be detected based on a switch or a sensor of the manual override state detector 160.

Accordingly and as mentioned above, it is desirable to detect, prevent and/or clear a “bowed rotor” condition in a gas turbine engine that may occur after the engine has been shut down. As described herein and in one non-limiting embodiment, the controller 102 may be programmed to automatically take the necessary measures in order to provide for a modified start sequence without pilot intervention other than the initial start request. In an exemplary embodiment, the controller 102 comprises a microprocessor, microcontroller or other equivalent processing device capable of executing commands of computer readable data or program for executing a control algorithm and/or algorithms that control the start sequence of the gas turbine engine. In order to perform the prescribed functions and desired processing, as well as the computations therefore (e.g., the execution of Fourier analysis algorithm(s), the control processes prescribed herein, and the like), the controller 102 may include, but not be limited to, a processor(s), computer(s), memory, storage, register(s), timing, interrupt(s), communication interfaces, and input/output signal interfaces, as well as combinations comprising at least one of the foregoing. For example, the controller 102 may include input signal filtering to enable accurate sampling and conversion or acquisitions of such signals from communications interfaces. As described above, exemplary embodiments of the disclosure can be implemented through computer-implemented processes and apparatuses for practicing those processes.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system comprising:
a starter air valve comprising a manual override, the starter air valve in fluid communication with an air turbine starter to drive motoring of a gas turbine engine responsive to a compressed air flow from a compressed air source; and
a pressure regulating bleed valve in fluid communication with the starter air valve, the pressure regulating bleed valve operable to bleed a portion of the compressed air flow to produce a bleed controlled starter air flow to limit a motoring speed of the gas turbine engine below a resonance speed of the gas turbine engine responsive to detection of the manual override in an open position.

2. The system as in claim 1, wherein the compressed air source is an auxiliary power unit, a ground cart, or a cross-engine bleed.

3. The system as in claim 1, further comprising a torque motor operable to open the pressure regulating bleed valve.

4. The system as in claim 1, further comprising a solenoid operable to open the pressure regulating bleed valve.

5. The system as in claim 1, further comprising a switch operable to detect the manual override in the open position.

6. The system as in claim 1, further comprising a sensor operable to detect the manual override in the open position.

7. The system as in claim 1, wherein the starter air valve and the pressure regulating bleed valve are integrally formed as a single line replaceable unit.

8. A system of an aircraft, the system comprising:
an air turbine starter coupled to a gearbox;
a starter air valve comprising a manual override, the starter air valve in fluid communication with the air turbine starter to drive motoring of a gas turbine engine responsive to a compressed air flow from a compressed air source;
a pressure regulating bleed valve in fluid communication with the starter air valve; and
a controller operable to actuate the pressure regulating bleed valve to bleed a portion of the compressed air flow to produce a bleed controlled starter air flow to limit a motoring speed of the gas turbine engine below a resonance speed of the gas turbine engine responsive to detection of the manual override in an open position.

9. The system as in claim 8, wherein the controller is operable to drive a torque motor to adjust the pressure regulating bleed valve.

10. The system as in claim 8, wherein the controller is operable to drive a solenoid to open the pressure regulating bleed valve.

11. The system as in claim 8, wherein the controller is coupled to a switch operable to detect the manual override in the open position.

12. The system as in claim 8, wherein the controller is coupled to a sensor operable to detect the manual override in the open position.

13. The system as in claim 8, wherein the starter air valve and the pressure regulating bleed valve are integrally formed as a single line replaceable unit.

14. A method comprising:
detecting a manual override of a starter air valve in an open position, wherein the starter air valve is in fluid communication with an air turbine starter to drive motoring of a gas turbine engine responsive to a compressed air flow from a compressed air source; and
controlling a pressure regulating bleed valve in fluid communication with the starter air valve to bleed a portion of the compressed air flow to produce a bleed controlled starter air flow to limit a motoring speed of the gas turbine engine below a resonance speed of the gas turbine engine responsive to detection of the manual override in the open position.

15. The method as in claim 14, wherein the compressed air source is an auxiliary power unit, a ground cart, or a cross-engine bleed.

16. The method as in claim 14, further comprising controlling a torque motor to open the pressure regulating bleed valve.

17. The method as in claim 14, further comprising controlling a solenoid to open the pressure regulating bleed valve.

18. The method as in claim 14, wherein the open position of the manual override is detected based on a switch.

19. The method as in claim 14, wherein the open position of the manual override is detected based on a sensor.

20. The method as in claim 14, wherein the starter air valve and the pressure regulating bleed valve are integrally formed as a single line replaceable unit.
